(19) United States
(12) Patent Application Publication
(10) Pub. No.: US 2010/0318550 A1
(43) Pub. Date: Dec. 16, 2010

(54) IMAGE SEARCHING SYSTEM, IMAGE SEARCHING APPARATUS, AND MEDIUM STORING IMAGE SEARCHING PROGRAM

(75) Inventors: Masashi YAMAMOTO, Chigasaki-shi (JP); Taketoshi KUMAZAKI, Tokyo (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/783,076

(22) Filed: May 19, 2010

(30) Foreign Application Priority Data
May 26, 2009 (JP) 2009-126107

(51) Int. Cl. G06F 17/30

(52) U.S. Cl. 707/765; 707/E17.019; 707/E17.014

(57) ABSTRACT

An image searching system is characterized by including a display unit capable of displaying a plurality of images arranged two-dimensionally, a range determining unit performing a determination of a search target range from an arrangement area of the plurality of images displayed on the display unit using a selected range set in advance, an image refining unit refining search target images by performing the determination of the search target range by the range determining unit a plurality of times until the selected range becomes a minimum selected range while gradually reducing the selected range, an image selecting unit selecting any of images included in the selected range when the selected range becomes the minimum selected range by performing the refining of the search target images by the image refining unit, and a display control unit causing the display unit to display, while maintaining a state of arrangement, images included in the search target range being determined each time the search target range is determined by the range determining unit when refining the search target images by the image refining unit, and causing the display unit to display a selected image when any of the images included in the selected range is selected by the image selecting unit.

### CROSS REFERENCE TO RELATED APPLICATION

This application is based upon and claims the benefit of priority from Japanese Patent Application No. 2009-126107, filed on May 26, 2009, the entire contents of which are incorporated herein by reference.

### BACKGROUND

1. Field

The present application relates to an image searching system that searches for an image intended by a user from a plurality of images, an image searching apparatus, and a storage medium that stores an image searching program.

2. Description of the Related Art

Conventionally, various image display devices that manage and display images stored in a database etc. have been devised. For example, an image display device has been devised (refer to Japanese Unexamined Patent Application Publication No. 2004-13575), in which a plurality of images is divided into groups using information, such as shooting date, and when a user selects a typical image intended by the user from among typical images of the respective groups displayed in a list, images in the group including the selected typical image are displayed in a list. In addition to this, another image display device has also been devised (refer to Japanese Unexamined Patent Application Publication No. 2008-85671), which displays all the captured images at a time by displaying an index image in which the captured images are arranged in divided display areas the number of which is equal to or larger than the number of captured images.

However, when the image display device described in Patent Document 1 is used, only typical images of the respective groups are displayed at the start of a search, and therefore, if a user is unaware of which group an image intended by the user is included in, it is necessary for the user to search for an intended image while confirming images for each group. When the image display device described in Patent Document 2 is used, the index image is updated each time the number of images increases and when the number of divided areas increases, the arrangement relationship between a predetermined image and a neighboring image changes accordingly, and it becomes difficult for a user to search for an intended image.

### SUMMARY

A proposition of the present application is to provide an image searching system, an image searching apparatus, and a storage medium that stores an image searching program, which are capable of easily searching for a target image when an image list using a plurality of images is displayed.

In order to solve the above-mentioned problems, an image searching system of the present application is characterized by including a display unit capable of displaying a plurality of images arranged two-dimensionally, a range determining unit that performs a determination of a search target range from an arrangement area of the plurality of images displayed on the display unit using a selected range set in advance, an image refining unit that refines search target images by performing the determination of the search target range by the range determining unit a plurality of times until the selected range becomes a minimum selected range while gradually reducing the selected range, an image selecting unit that selects any of images included in the selected range when the selected range becomes the minimum selected range by performing the refining of the search target images by the image refining unit, and a display control unit that causes the display unit to display, while maintaining a state of arrangement, images included in the search target range being determined each time the search target range is determined by the range determining unit when refining the search target images by the image refining unit, and that causes the display unit to display a selected image when any of the images included in the selected range is selected by the image selecting unit.

It is preferable for the display control unit to redisplay the plurality of images displayed on the display unit at the time of the determining the search target range when the search target range determined by the range determining unit is changed in a process of refining the search target images by the image refining unit.

It is also preferable for the minimum selected range to be a range in a rectangle shape when a preset number of images is arranged in a matrix, and preferable for the selected range to be a range similar to the minimum selected range and different from the minimum selected range in size.

It is also preferable to further include an image arranging unit that arranges the plurality of images two-dimensionally by arranging a group of images in a predetermined arrangement sequence, the group of images has images arranged in accordance with the minimum selected range.

It is also preferable for the plurality of images to arrange in fixed positions, and for the image arranging unit, when any of the plurality of images is deleted, to keep an area where a deleted image is once arranged empty and to arrange the images excluding the deleted image.

It is also preferable for the plurality of images to arrange in fixed positions, and for the image arranging unit, when any of the plurality of images is deleted, to firstly arrange an image different from the plurality of images in an area where a deleted image is once arranged and then to arrange the images excluding the deleted image.

It is also preferable to have an electronic device including at least the display unit and the display control unit, a server capable of connecting to the electronic device via a network, and an image storing unit that stores the plurality of images, in which the image storing unit is provided in at least one of the electronic device and the server.

An image searching system of the present application is characterized by including a display unit capable of displaying a plurality of images arranged two-dimensionally, a range determining unit that performs a determination of a search target range from an arrangement area of the plurality of images displayed on the display unit using a selected range set in advance, an image refining unit that refines search target images by performing the determination of the search target range by the range determining unit a plurality of times until the selected range becomes a minimum selected range while gradually reducing the selected range, and a display control unit that causes the display unit to display, while maintaining a state of arrangement, images included in the search target range being determined each time the search target range is determined by the range determining unit when refining the search target images by the image refining unit.

An image searching apparatus of the present application is characterized by including a display unit capable of displaying a plurality of images arranged two-dimensionally, a range determining unit that performs a determination of a search target range from an arrangement area of the plurality of images displayed on the display unit using a selected range set in advance, an image refining unit that refines search target images by performing the determination of the search target range by the range determining unit a plurality of times until the selected range becomes a minimum selected range while gradually reducing the selected range, an image selecting unit that selects any of images included in the selected range when the selected range becomes the minimum selected range by performing the refining of the search target images by the image refining unit, and a display control unit that causes the display unit to display, while maintaining a state of arrangement, images included in the search target range being determined each time the search target range is determined by the range determining unit when refining the search target images by the image refining unit, and that causes the display unit to display a selected image when any of the images included in the selected range is selected by the image selecting unit.

A storage medium that stores an image searching program of the present application is a computer-readable medium storing the image searching program to cause a computer to execute a range determining step performing a determination of a search target range from an arrangement area of a plurality of images to be displayed using a selected range set in advance, an image refining step refining search target images by performing the determination of the search target range in the range determining step a plurality of times until the selected range becomes a minimum selected range while gradually reducing the selected range, a first display step causing the display unit to display images included in the search target range being determined maintaining a state of arrangement each time the search target range is determined in the range determining step when refining the search target images in the image refining step, an image selecting step selecting any of images included in the selected range when the selected range becomes the minimum selected range by performing the refining of the search target images in the image refining step refining, and a second display step displaying a selected image in the image selecting step.

### BRIEF DESCRIPTION OF THE DRAWINGS

FIG. 1 is a diagram showing an outline of a configuration of an image searching system.

FIG. 2 is a diagram showing an outline of a configuration of a display device.

FIG. 3 is a diagram showing a configuration of an arrangement area in a first arrangement area.

FIG. 4 is a diagram showing a configuration of an arrangement area in a second arrangement area.

FIG. 5 is a diagram showing a configuration of an arrangement area in a third arrangement area.

FIG. 6 is a flowchart showing a flow of processing in a display device when searching for an image.

FIG. 7 is a flowchart showing a flow of processing in an image search server when searching for an image.

FIG. 8 is a flowchart showing a flow of processing in an image search server when searching for an image.

FIG. 9 is a diagram showing a display state of an image list with the third image arrangement area as a display range.

FIG. 10 is a diagram showing a display state of an image list with the second image arrangement area as a display range.

FIG. 11 is a diagram showing a display state of an image list with the first image arrangement area as a display range.

FIG. 12 is a diagram showing a display state of an image intended by a user.

FIG. 13 is a diagram showing an arrangement state of search target images.

FIG. 14 is a diagram showing an arrangement example of search target images in the first image arrangement area.

FIG. 15 is a diagram showing a configuration of an electronic device capable of searching for an image.

FIG. 16 is a flowchart showing a flow of processing when searching for an image.

FIG. 17 is a flowchart showing a flow of processing when searching for an image.

FIG. 18 is a diagram showing a case when the electronic device shown in FIG. 15 and an image search server are network-connected.

### DETAILED DESCRIPTION OF THE EMBODIMENTS

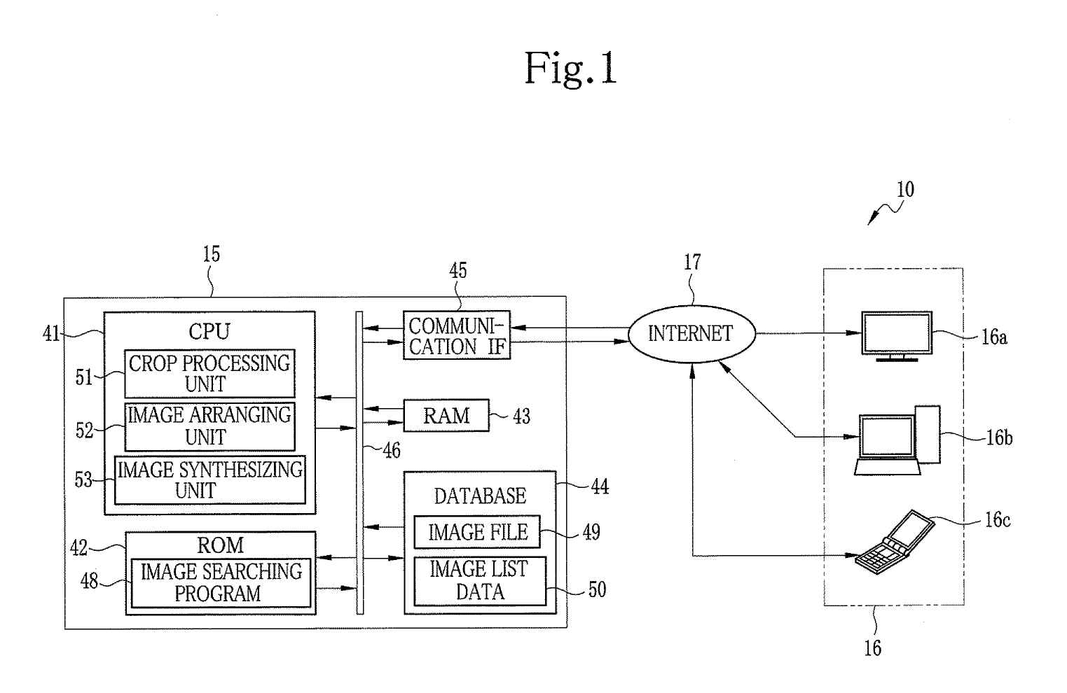

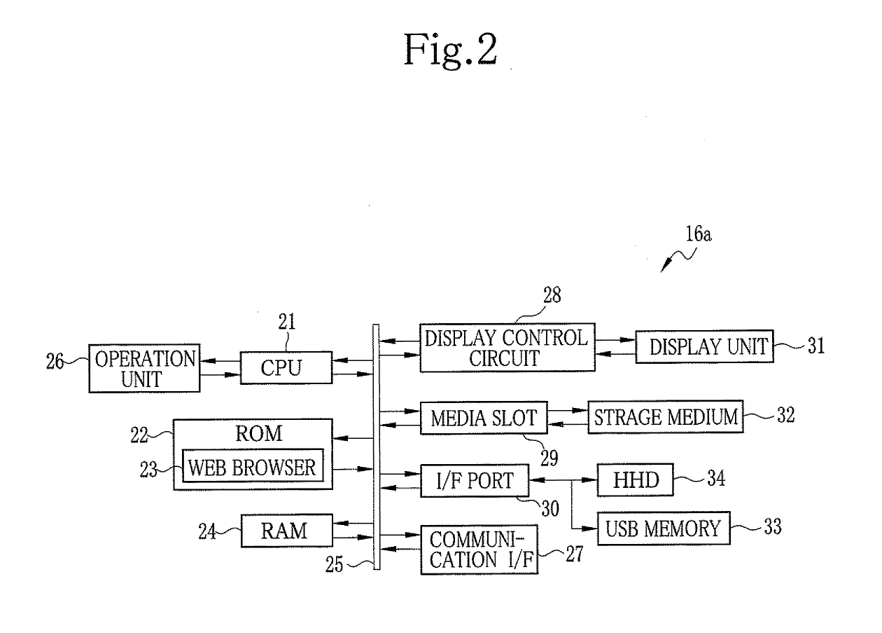

FIG. 1 is a diagram showing an outline of a configuration of an image searching system 10 of the present invention and FIG. 2 is a diagram showing an outline of a configuration of a display device 16a constituting the image searching system 10. As shown in FIG. 1, the image searching system 10 includes an image search server 15 and an electronic device 16. The electronic device 16 and the image search server 15 are network-connected via an Internet 17. An example of the electronic device 16 may include an electronic device having a display unit or capable of connection with a display unit, such as a display device 16a, a PC 16c, and a mobile-phone 16c. Hereinafter, the display device 16a is taken as an example to explain the electronic device 16.

An example of the display device 16a includes a television (TV). The display device 16a, a CPU 21 totally controls each part of the display device 16a by executing control programs (not shown schematically) stored in a ROM 22. To the CPU 21, an operation signal from an operation unit 26 is input, to be described later, and therefore, processing based on the operation signal is performed. The ROM 22 stores application software called a WEB browser 23 in addition to the control programs. The WEB browser 23 is connected with the image search server 15 via the Internet 17 by being executed by the CPU 21. Due to this, it is made possible to transmit and receive various signals and data between the display device 16a and the image search server 15. A RAM 24 temporarily stores numerical values produced at the time of control by the CPU 21 and various signals and data transmitted from the image search server 15. The CPU 21 is connected with a communication I/F 27, a display control circuit 28, a media slot 29, an I/F port 30, etc., via a bus 25, in addition to the ROM 22 and the RAM 24 described above.

The operation unit 26 is operated to specify a selection area when an image list is displayed on a display unit 31 at the time of an image search. This selection area is used to refine a searching targeted range from an arrangement area of a plurality of images arranged two-dimensionally. The selection area changes its size in accordance with the number of images to be displayed as an image list. Actually, as a display showing a selection area, an area frame, to be described later, is cited.

The operation unit 26 is also operated to change a display magnification. By changing the display magnification, the number of images to be displayed on the display unit 31 is changed. For example, when the display magnification is increased, the number of images to be displayed on the display unit 31, that is, the number of search target images is narrowed down. Hereinafter, when one image is displayed on the display unit 31, it is called that the enlargement factor is the maximum. On the other hand, when the display magnification is reduced, the number of images to be displayed on the display unit 31 is increased. Hereinafter, when all of the images are displayed, it is called that the reduction factor is the maximum.

In the present embodiment a television is cited as the display device 16a, and therefore, as the operation unit 26, the input operation unit 26 provided in the display device 16a, a remote controller, or the like is cited. If a mouse or keyboard can be connected, the mouse or keyboard can also function as the operation unit 26. As the communication I/F 27, a router, a modem, or the like is cited. The display device 16a is connected to the Internet 17 via the communication I/F 27.

The display control circuit 28 controls the drive of the display unit 31. When the display device 16a is a liquid crystal display device, the display unit 31 includes a liquid crystal panel and a backlight, and therefore, the display control circuit 28 controls the drive of the liquid crystal panel and the backlight. Into and from the media slot 29, a storage medium 32, such as a memory card, optical disc, and magnetic disc, is inserted and removed. The I/F port 30 includes, for example, a connection port to which a cable terminal based on the USB standard is connected, a connection port to which a cable terminal based on the IEEE standard is connected, etc. Via the I/F port 30, a USB memory 33, a hard disc drive (HDD) 34, etc., are connected electrically.

The image search server 15 to which the electronic device 16 including the display device 16a as above is network-connected has the following configuration. The image search server 15 includes a CPU 41, a ROM 42, a RAM 43, a database 44, a communication I/F 45, etc. These components are connected via a bus 46. The CPU 41 totally controls each part of the image search server 15. The ROM 42 stores an image searching program 48 and a control program, not shown schematically. The RAM 43 temporarily stores an operator calculated by the CPU 41 executing these programs, received data, etc.

The database 44 stores an image file 49. In general, a plurality of users connects to the image search server 15, and therefore, in general, the image files 49 stored in the database 44 are put together and stored into a folder created for each user capable of connecting to the image search server 15. In the present embodiment, however, for the sake of simplification of explanation, the image search server 15 to which only one use can connect is explained. The above-described image file 49 is an image file including still images or a motion picture captured by a digital camera or a mobile-phone with a camera function. When the image file 49 is based on still images, the image file 49 includes supplementary information, such as information about shooting, in addition to still image data and thumbnail image data. Further, the database 44 stores a plurality of pieces of image data 50 from which an image list is created (hereinafter, referred to as list image data).

The above-described CPU 41 comes to have functions of a crop processing unit 51, an image arranging unit 52, and an image synthesizing unit 53 by executing the image searching program 48 stored in the ROM 42.

The crop processing unit 51 reads thumbnail image data read from the image file 49 stored in the database 44 and performs crop processing. As publicly known, the crop processing is processing to cut out a necessary area from an image.

For example, an aspect ratio of 4:3 (the ratio of width to height is 1.33:1) or an aspect ratio of 16:9 (the ratio of width to height is 1.78:1) is used in general for an image captured by shooting. Hence, the crop processing unit 51 performs crop processing for each image so that the aspect ratio of the image after the crop processing is 1:1. For example, when an image is horizontally elongated, only the center of the image is cut out with the right and left parts of the image left over. When an image is vertically elongated, only the center of the image is cut out with the upper and lower parts left over. In other words, the long sides are cut in accordance with the lengths of short sides. This crop processing is performed on the thumbnail image data of all of the image files 49 stored in the database 44.

The image arranging unit 52 performs resize processing to make the same the image size on the image data having been subjected to crop processing, and then, arranges the image data having been subjected to the resize processing. Hereinafter, the image data having been subjected to the resize processing is referred to as image data for searching. The image data for searching is arranged in a predetermined arrangement sequence according to, for example, shooting dates. It is not necessary to be limited to the shooting dates and it may also be possible to arrange the data according to, for example, events, or subjects included in images.

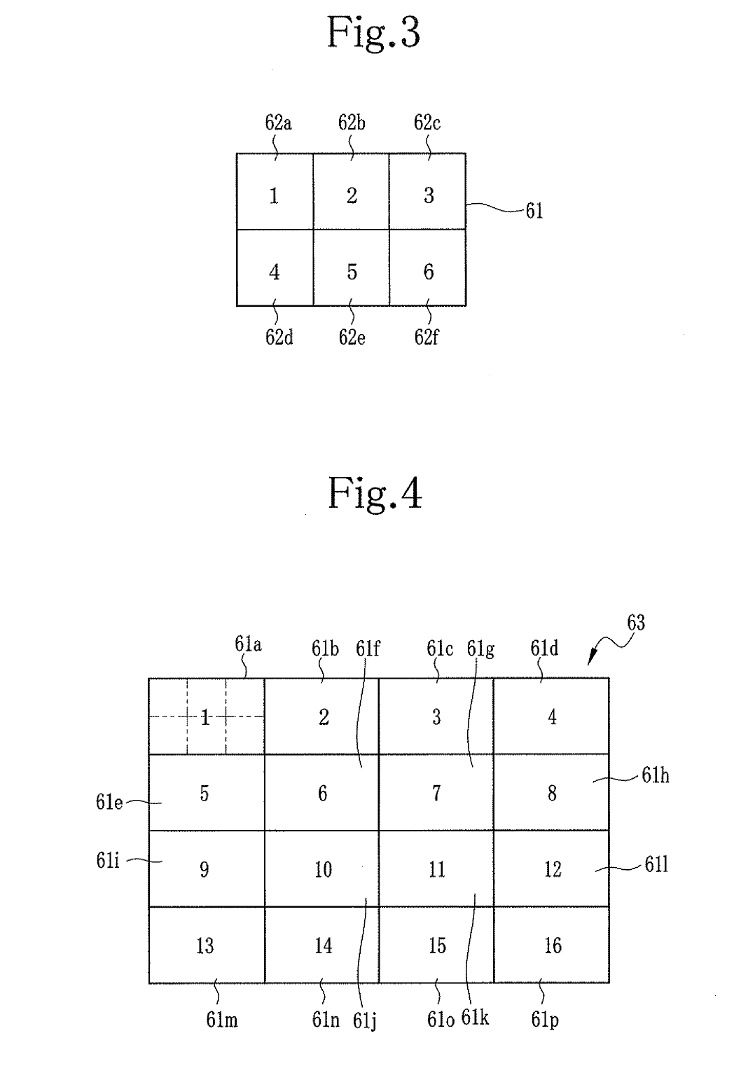

A procedure to arrange search target images will be described below. The image arranging unit 52 arranges the search target images, respectively, so as to form a first image arrangement area 61 in which the minimum number of images is arranged, for example, six images in total, that is, two in the vertical direction and three in the horizontal direction, etc. As shown in FIG. 3, the arrangement sequence of the search target images when forming the first image arrangement area 61 is an arrangement area 62a, an arrangement area 62b, an arrangement area 62c, an arrangement area 62d, an arrangement area 62e, and an arrangement area 62f.

As shown in FIG. 4, after forming a first image arrangement area 61a in which search target images are arranged, the image arranging unit 52 arranges search target images on the right side of the first image arrangement area 61a formed. Then, after forming a first image arrangement area 61b, the image arranging unit 52 arranges search target images in an area 61c. Then, after arranging four first image arrangement areas in the horizontal direction, that is, the first image arrangement areas 61a to 61c and a first image arrangement area 61d, the image arranging unit 52 arranges search target images in a position beneath the first image arrangement area 61a. Due to this, four first image arrangement areas 61e to 61h are formed in the horizontal direction. Similarly, the image arranging unit 52 arranges search target images in an arrangement sequence of an area 61i, an area 61j, an area 61k, and an area 61l and thus forms first image arrangement areas. Finally, the image arranging unit 52 arranges search target images in an arrangement sequence of an area 61m, an area 61n, an area 61o, and an area 61p and thus forms first image arrangement areas. In this manner, a second image arrangement area 63 is formed by combining the 16, in total, first image arrangement areas 61, that is, four in the vertical direction and four in the horizontal direction.

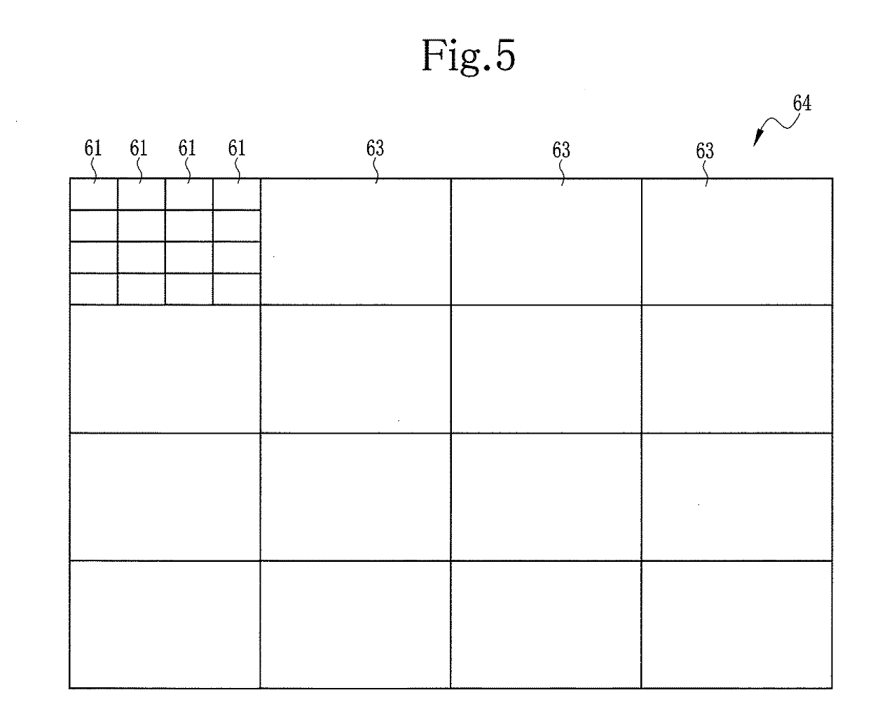

After forming the second image arrangement area 63, the image arranging unit 52 arranges search target images on the right side of the second image arrangement area 63 formed. This procedure to arrange search target images is the same as the procedure described above, and therefore, its explanation is omitted here. Due to this, a third image arrangement area 64 is formed. The sequence of the positions where the third image arrangement area 64 is formed is the same as the sequence of the positions where the second image arrangement area 63 is formed. In this manner, the third image arrangement area 64 is formed by combining the 16, in total, second image arrangement areas 63, that is, four in the vertical direction and four in the horizontal direction (refer to FIG. 5).

The image synthesizing unit 53 produces images for an image list by synthesizing images arranged by the image arranging unit 52. The list image data 50 from which images for the image list are produced is stored in the database 44. When the image list is displayed, the list image data 50 is transmitted to the image device 16a.

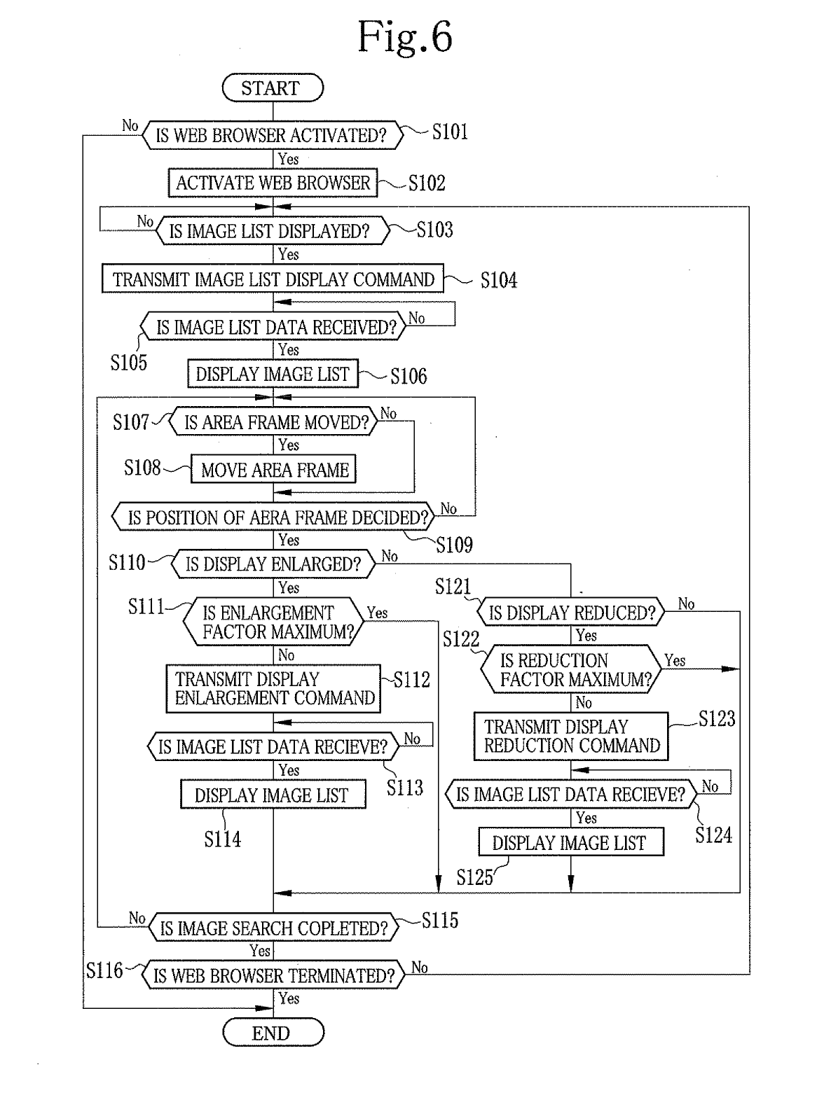

Next, a flow of processing in the image device when searching for an image will be described based on the flowchart in FIG. 6.

Step S101 is processing to determine whether or not the WEB browser 23 is activated. When the operation unit 26 is operated, an operation signal from the operation unit 26 is input to the CPU 21. When the operation signal input to the CPU 21 is a signal to activate the WEB browser 23, the CPU 21 determines to activate the WEB browser 23. In this case, the determination result in step S101 is Yes and the flow advances to step S102. On the other hand, when the operation signal input to the CPU 21 is a signal other than the signal to activate the WEB browser 23, the CPU 21 determines not to activate the WEB browser 23. In this case, the determination result in step S101 is No and processing based on the operation signal is performed. In this case, the processing based on the operation signal is performed but processing relating to an image search is not performed, and therefore, the processing of this flowchart is terminated.

Step S102 is processing to activate the WEB browser 23. The CPU 21 reads the WEB browser 23 stored in the ROM 22 and activates the WEB browser 23 read therefrom. When activating the WEB browser 23, the CPU 21 transmits an activation command indicative of that the WEB browser 23 has been activated to the image search server 15. When the image search server 15 executes the image searching program 48, the image data from which menu images are produced is transmitted to the display device 16a. In response to this, the CPU 21 outputs menu image data to the display control circuit 28. Consequently, the display control circuit 28 causes the display unit 31 to display the menu images.

Step S103 is processing to determine whether or not there is an instruction to display an image list. When the operation signal from the operation unit 26 is an instruction signal to display an image list, the CPU 21 determines Yes in step S103. In this case the flow advances to step S104. On the other hand, when the operation signal from the operation unit 26 is not the instruction signal to display an image list, the CPU 21 determines No in step S103. In this case, the determination processing in this step S103 is performed until an operation signal indicative of an instruction to display an image list is input to the CPU 21.

Step S104 is processing to transmit an image list display command. The CPU 21 transmits the image list display command to the image search server 15.

Step S105 is processing to determine whether or not list image data is received. When the list image data 50 is received, the CPU 21 determines Yes in step S105. In this case, the flow advances to step S106. The list image data 50 is temporarily stored in the RAM 24. On the other hand, when the list image data 50 is not received, the CPU 21 determines No in step S105. In this case, the determination processing in step S105 is performed repeatedly until the list image data 50 is received.

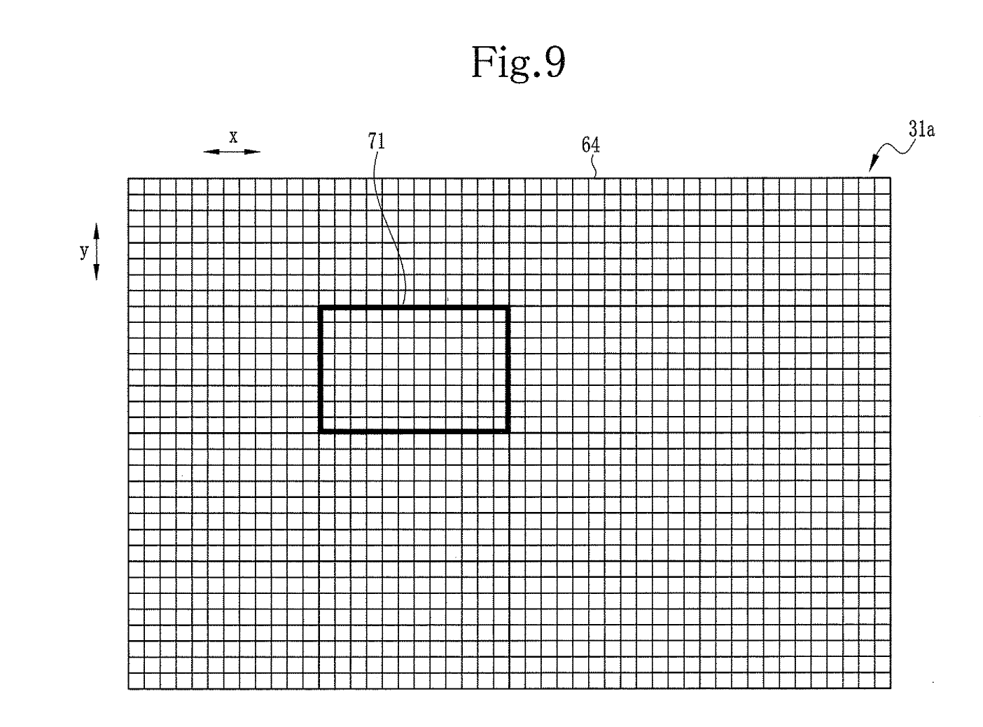

Step S106 is a processing to display an image list. The CPU 21 reads the list image data 50 stored in the RAM 24 and outputs the data to the display control circuit 28. Due to this, the display unit 31 displays an image list. As an image list, an image list is cited which uses the third image arrangement area 64 as a display range as shown in FIG. 9. In FIG. 9, in order to avoid the complication of the figure, images to be arranged in each image arrangement area are omitted. When the image list with the third image arrangement area 64 as a display range is displayed on the display unit 31, an area frame 71 indicating a selection area is displayed being overlapped with the image list. In this case, as the size of the area frame 71, the size of the second image arrangement area 63 is used.

Step S107 is processing to determine whether or not to move the area frame. When an operation signal from the operation unit 26 is input to the CPU 21, the CPU 21 determines whether or not the input operation signal is a signal to move the area frame 71. For example, when the operation signal from the operation unit 26 is a signal to select an area, the CPU 21 determines Yes in step S107. On the other hand, when the operation signal from the operation unit 26 is not the signal to select a selection area, the CPU 21 determines No in step S107. In this case, the flow advances to step S109.

Step S108 is processing to move the area frame. In step S107, the CPU 21 determines that the operation signal input to the CPU 21 is the signal to move the area frame 71, and therefore, the CPU 21 outputs a signal indicating a direction in which the area frame 71 is moved based on the operation signal to the display control circuit 28. Upon receipt of this signal, the display control circuit 28 moves the area frame 71 displayed overlapped with the image list in an x direction or y direction illustrated in FIG. 9.

Step S109 is processing to determine whether or not to decide the position of the area frame. When the operation signal from the operation unit 26 is a signal to decide the position of the area frame 71, the CPU 21 determines Yes in this step S109. In this case, the flow advances to step S110. On the other hand, when there is no operation signal from the operation unit 26 or the signal is a different one, the CPU 21 determines No in this step S109. In this case, the flow returns to step S107.

Step S110 is processing to determine whether or not to enlarge a display. When the operation signal from the operation unit 26 is a signal to enlarge a display, the CPU 21 determines Yes in this step S110 and the flow advances to step S111. On the other hand, when the operation signal is not the signal to enlarge a display, the CPU 21 determines No in this step S110 and the flow advances to step S121.

Step S111 is processing to determine whether or not the enlargement factor is the maximum. At least an upper limit is set to the enlargement factor when an image list is displayed. When this enlargement factor is the maximum, the CPU 21 determines Yes in step S111. In this case, the flow advances to step S115. On the other hand, when the enlargement factor is not the maximum, the CPU 21 determines No in step S111 and the flow advances to step S112.

Step S112 is processing to transmit a display enlargement command to the image search server 15. The display control circuit 28 outputs information about the size and position of the area frame to the CPU 21. Upon receipt of this information, the CPU 21 transmits the display enlargement command to the image search server 15 after attaching the information about the size and position of the area frame to the display enlargement command.

Step S113 is processing to determine whether or not the list image data is received. When the list image data 50 is received, the CPU 21 determines Yes in this step S113. In this case, the flow advances to step S114. The received list image data 50 is temporarily stored in the RAM 24. On the other hand, when the list image data 50 is not received, the CPU 21 determines No in this step S113. In this case, the determination processing in this step S113 is performed until the list image data 50 is received.

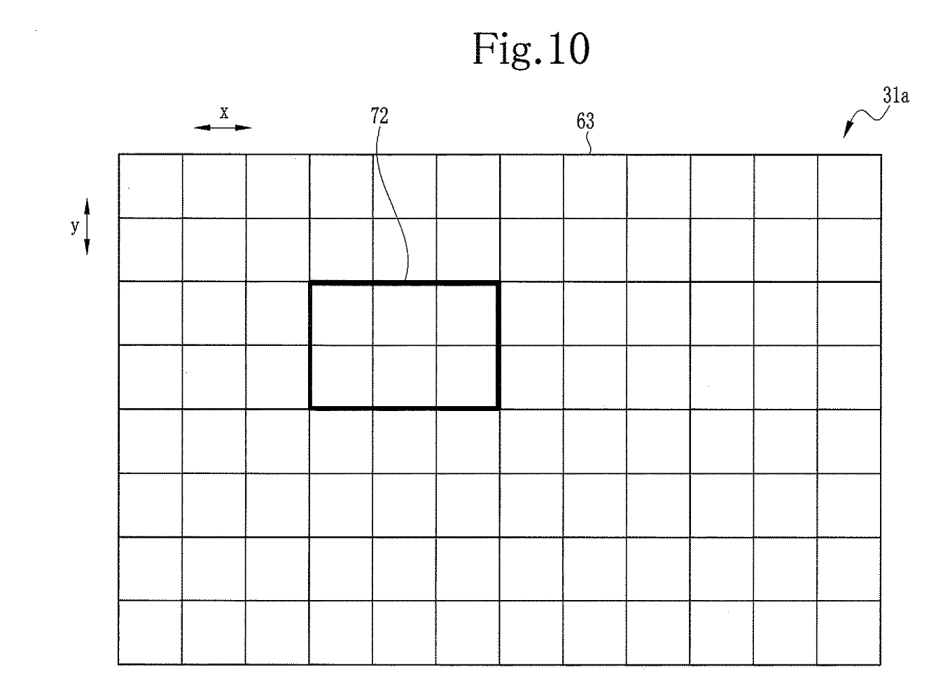

Step S114 is processing to display an image list. The CPU 21 outputs the list image data 50 stored in the RAM 24 to the display control circuit 28. In response to this, the image displayed on the display unit 31 is replaced with another. For example, when an image list with the third image arrangement area 64 as a display range is displayed on a display screen 31a of the display unit 31, the area frame 71 is selected from among any one of the second image arrangement areas 63 included in the third image arrangement area 64, and therefore, the display of the image list with the third image arrangement area 64 as a display range is switched to a display of an image list with the selected second image arrangement area 63 as a display range (refer to FIG. 9 and FIG. 10). When switching image lists, for example, it is possible to display in a pseudo manner the way the images included in the area frame 71 are enlarged, respectively.

The third image arrangement area 64 has the second image arrangement areas 63 arranged four in the vertical direction and four in the horizontal direction, which in total of 16, and therefore, the number of images when the image list with the second image arrangement area 63 as a display range is displayed is 1/16 of the number of images when the image list with the third image arrangement area 64 as a display range is displayed. On the other hand, the display area of an image when the image list with the second image arrangement area 63 as a display range is displayed is 16 times the display area of an image when the image list with the third image arrangement area 64 as a display range is displayed. When the image list with the second image arrangement area 63 as a display range is displayed on the display screen 31a of the display unit 31, the area frame 72 indicating a selection area is displayed being overlapped with any one of the first image arrangement areas 61. In this case, the size of the area frame 72 is the size of the arrangement area 62.

Step S115 is processing to determine whether or not to end the image search. When the operation signal from the operation unit 26 is a signal to end the image search, the CPU 21 determines Yes in this step S115. In this case, the flow advances to step S116. On the other hand, when the operation signal from the operation unit 26 is not the signal to end the image search, the CPU 21 determines No in this step S115. In this case, the flow returns to step S107.

Step S116 is processing to determine whether or not to terminate the WEB browser 23. When the operation signal from the operation unit 26 is a signal to terminate the WEB browser 23, the CPU 21 determines Yes in step S116. In this case, a series of processing is ended. At this time, when terminating the WEB browser 23, the CPU 21 transmits an end command to the image search server 15. On the other hand, when the operation signal from the operation unit 26 is not the signal to terminate the WEB browser 23, the CPU 21 determines No in step S116. In this case, the flow returns to step S103.

In step S110, when the operation signal input to the CPU 21 is not the signal to enlarge a display, the flow advances to step S121.

Step S121 is processing to determine whether or not to reduce a display. When the operation signal from the operation unit 26 is a signal to reduce a display, the CPU 21 determines Yes in this step S121 and the flow advances to step S122. On the other hand, when the operation signal is not the signal to reduce a display, the CPU 21 determines No in this step S121 and the flow advances to step S115.

Step S122 is processing to determine whether or not the reduction factor is the maximum. At least an upper limit is set to the reduction factor when an image list is displayed. When the reduction factor is the maximum, the CPU 21 determines Yes in step S122. In this case, the flow advances to step S115. On the other hand, when the reduction factor is not the maximum, the CPU 21 determines No in step S122 and the flow advances to step S123.

Step S123 is processing to transmit a display reduction command to the image search server 15. The display control circuit 28 outputs information about the size and position of the area frame to the CPU 21. Upon receipt of this information, the CPU 21 transmits the display reduction command to the image search server 15 after attaching the information about the size and position of the area frame to the display reduction command.

Step S124 is processing to determine whether or not the list image data is received. When the list image data 50 is received, the CPU 21 determines Yes in this step S124. In this case, the flow advances to step S125. The received list image data 50 is temporarily stored in the RAM 24. On the other hand, when the list image data 50 is not received, the CPU 21 determines No in this step S124. In this case, the determination processing in this step S124 is performed until the list image data 50 is received.

Step S125 is processing to display an image list. The CPU 21 outputs the list image data 50 stored in the RAM 24 to the display control circuit 28. Upon receipt of the data, the display control circuit 28 displays images based on the list image data 50 on the display unit 31. Due to this, the image list of the reduced images to be arranged in the decided area frame is displayed. In this case, the area frame with the size in accordance with the reduction factor is overlapped on the image list. After the processing is performed, the flow advances to step S115.

For example, as shown in FIG. 10, when the display is reduced while the image list with the second image arrangement area 63 as a display range is displayed, the image list is switched to the image list with the third image arrangement as a display range (refer to FIG. 9). As described above, in the third image arrangement area 64, the 16, in total, second image arrangement areas 63 are arranged, four in the vertical direction and four in the horizontal direction, and therefore, when the image list with the second image arrangement area 63 as a display range is switched to the image list with the third image arrangement area 64 as a display range, the number of images to be displayed is 16 times the previous number and the display area of an image is reduced to 1/16.

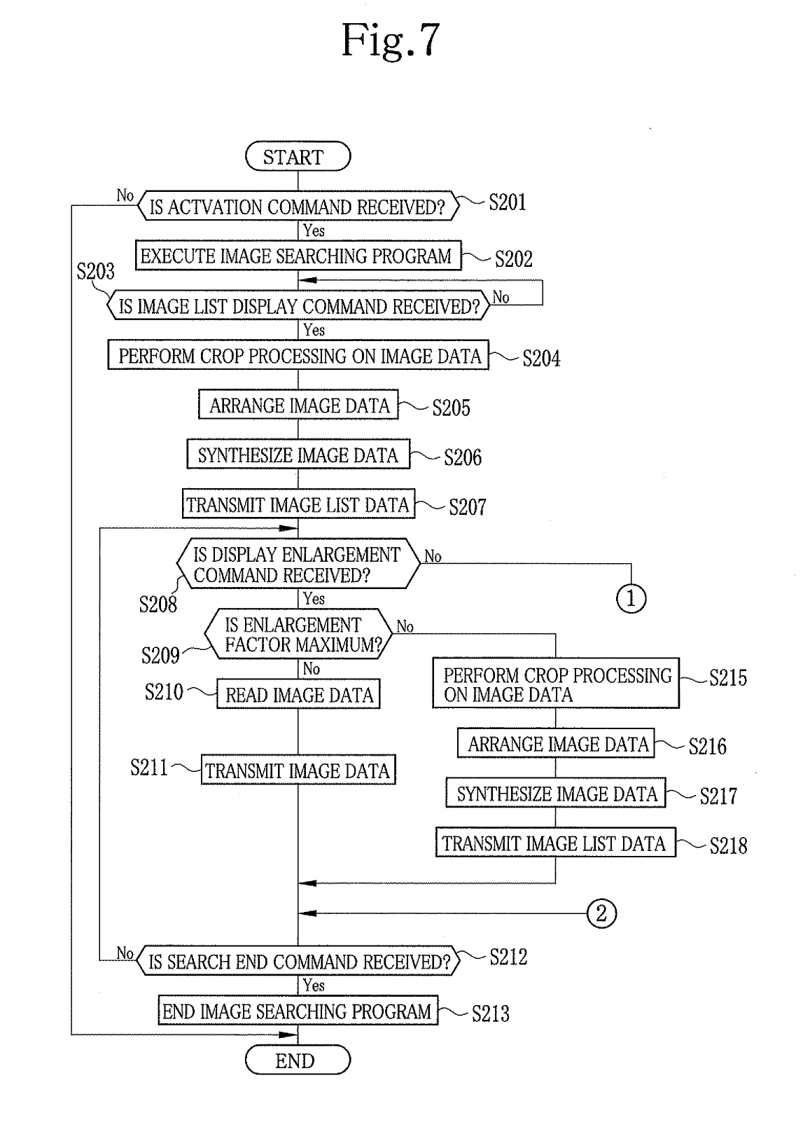

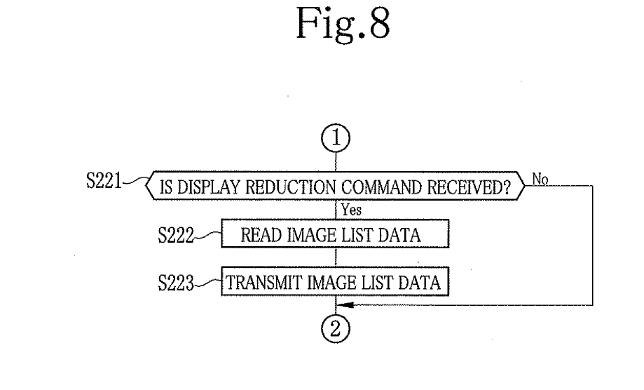

Next, a flow of processing of the image search server 15 when searching for an image will be described based on a flowchart shown in FIG. 7 and FIG. 8. Step S201 is processing to determine whether or not an activation command is received. When the WEB browser is activated on the display device 16a, the activation command is transmitted from the display device 16a to the image search server 15. When the activation command is received, the CPU 41 determines Yes in this step S201. In this case, the flow advances to step S202. On the other hand, when the activation command is not received, the CPU 41 determines No in step S201 and the determination processing in step S201 is performed repeatedly until it is determined that the activation command is received.

Step S202 is processing to execute the image searching program. The CPU 41 reads the image searching program 48 stored in the ROM 42 and executes the application software. The CPU 41 transmits image data from which menu images are produced to the display device 16a by executing the image searching program 48.

Step S203 is processing to determine whether or not an image list display command is received. When an image list display command is received from the display device 16a, the CPU 41 determines Yes in this step S203 and the flow advances to step S204. On the other hand, when the image list display command is not received, the CPU 41 determines No in step S203. In this case, the determination processing in this step S203 is performed repeatedly until the image list display command is received.

Step S204 is crop processing for image data. The CPU 41 reads thumbnail image data from the image file stored in the database 44. Then, the center part of the image is cut out so that the aspect ratio of the image based on the thumbnail image data is 1:1. At this time, the length of the short side of the image is the same before the crop processing and after the crop processing. The crop processing in this step S204 is performed on the thumbnail image data stored in all of the image files stored in the database 44.

Step S205 is processing to arrange image data. The CPU 41 performs resize processing on the image data having been subjected to the crop processing performed in step S204 so that the image size is a fixed one. Due to this, the image data (image data for searching) from which search target images are produced is produced. When the image size of the image data having been subjected to the crop processing is the same as the image size of the image data for searching to be arranged, the image data having been subjected to the crop processing is used as image data for searching.

The image data for searching is arranged by a procedure shown below. First, the CPU 41 arranges search target images in the sequence of the arrangement area 62a, the arrangement area 62b, the arrangement area 62c, the arrangement area 62d, the arrangement area 62e, and the arrangement area 62f. Consequently, the first image arrangement area 61a is formed (refer to FIG. 4). When the arrangement of images in the first image arrangement area 61a is completed, search target images are arranged in the area 61b by the same procedure and thus the first image arrangement area is formed. After that, images are arranged in the sequence of the area 61c, the area 61d, the area 62e, the area 61f, the area 61g, . . . , the area 61p and each first image arrangement area 61 is formed. By combining the 16, in total, first image arrangement areas 61, four in the vertical direction and four in the horizontal direction, the second image arrangement area 63 is formed. Similarly, by combining the 16, in total, second image arrangement areas 63, four in the vertical direction and four in the horizontal direction, the third image arrangement area 64 is formed. When all of the search target images are arranged, the processing in step S205 is completed.

Step S206 is processing to synthesize image data. In step S207, all of the search target images having been subjected to the crop processing are already arranged, and therefore, the CPU 41 synthesizes the arranged search target images and produces one image. The image data from which the synthesized image is produced is stored in the database 44 as the list image data 50.

Step S207 is processing to transmit list image data. The CPU 41 reads the list image data 50 stored in the database and transmits the list image data 50 to the display device 16a.

Step S208 is processing to determine whether or not a display enlargement command is received. When an image list is enlarged, the display enlargement command is transmitted to the image search server 15 from the display device 16a. When the display enlargement command is received, the CPU 41 determines Yes in step S208 and the flow advances to step S209. On the other hand, when the display enlargement command is not received, the CPU 41 determines No in step S208 and the flow advances to step S221.

Step S209 is processing to determine whether or not the enlargement factor is the maximum. To the display enlargement command, information about the size and position of the area frame is attached. The CPU 41 determines whether or not the size of the area frame is the size of a search target image. For example, when the size of the area frame is the size of the search target image, the enlargement factor to be specified is the maximum, and therefore, the CPU 41 determines Yes in step S209. In this case, the flow advances to step S211. On the other hand, when the size of the area frame is larger than or equal to that of the first image arrangement area 61, the enlargement factor to be specified is not the maximum, and therefore, the CPU 41 determines No in step S209. In this case, the flow advances to step S215.

Step S210 is processing to read image data. In step S210, the size of the area frame is determined to be the size of the search target image. Further, to the display enlargement command, information about the position of the area frame is attached. The CPU 41 identifies a search target image from the information about the position of the area frame and the list image data stored in the database 44. Then, the CPU 41 reads thumbnail image data or still image data from the image file from which the identified search target image is produced.

Step S211 is processing to transmit image data. In step S210, the thumbnail image data or still image data is read, and therefore, the CPU 41 transmits the image data that is read to the display device 16a as the image list data 50.

Step S212 is processing to determine whether or not an image search end command is received. When an image search end command is received from the display device 16a, the CPU 41 determines Yes in this step S212 and the flow advances to step S213. On the other hand, when the image search end command is not received from the display device 16a, the CPU 41 determines No in this step S212 and the flow returns to step S208.

Step S213 is processing to end the image searching program. After this step S213 is performed, the image search using the network connection is completed.

On the other hand, when the result of the determination processing in step S209 is No, that is, the enlargement factor to be specified is not the maximum, the flow advances to step S215.

Step S215 is crop processing for image data. The CPU 41 identifies a search target image included in the area frame using the list image data and the information about the position of the area frame attached to the display enlargement command. Then, the CPU 41 reads thumbnail image data from the image file based on the identified search target image. Then, the center part of the image is cut out so that the aspect ratio of the image based on the thumbnail image data is 1:1.

Step S216 is processing to arrange image data. The CPU 41 performs resize processing on the image data having been subjected to the crop processing so that the image size is a fixed one and produces image data for searching. Each piece of the image data is arranged using the produced image data for searching.

Step S217 is processing to synthesize image data. In step S216, all of the image data for searching is arranged, and therefore, the CPU 41 synthesizes arranged image data for searching and produces the list image data 50. The produced list image data 50 is stored in the database 44.

Step S218 is processing to transmit list image data. The CPU 41 reads the list image data produced in step S217. Then, the CPU 41 transmits the read list image data to the display device 16a. When the processing in this step S218 is performed, the flow advances to step S212. Consequently, when the display enlargement command is received, the thumbnail image data based on the information about the size and position of the area frame to which the display enlargement command is attached is read and the list image data is produced.

When the result of the determination processing in step S208 is No, that is, when the received command is not the display enlargement command, the flow advances to step S221.

Step S221 is processing to determine whether or not a display reduction command is received. When the image list is reduced, the display reduction command is transmitted to the image search server 15 from the display device 16a. When the display reduction command is received, the CPU 41 determines Yes in step S221 and the flow advances to step S222. On the other hand, when the display reduction command is not received, the CPU 41 determines No in step S221 and the flow advances to step S212.

Step S222 is processing to read list image data. The CPU 41 reads the list image data second newly produced from the past list image data 50 stored in the database 44. The list image data most recently produced is the image data from which the image list displayed on the display unit 31 of the display device 16a is created.

Step S223 is processing to transmit list image data. The CPU 41 transmits the list image data 50 read from the database 44 to the display device 16a. After the processing in this step S223 is completed, the flow advances to step S212. As described above, when the display reduction command is received, it is only required to read the list image data stored in the database 44 without the need to newly produce list image data, and therefore, the time and effort required to produce list image data can be saved.

The display system of the display unit 31 will be described below. As shown in FIG. 9, when an image list with the third image arrangement area 64 as a display range is displayed as a display of an image list, the area frame 71 having the size of the second image arrangement area 63 is displayed on the display screen 31a of the display unit 31 along with the image list. When a user operates the operation unit 26, the area frame 71 moves in the x direction or in the y direction. At this time, the area frame 71 moves while shifting one area each time so as to include the neighboring second image arrangement area 63. When the position of the area frame 71 reaches the position intended by the user, the user operates to enlarge the display after operating the operation unit 26 to decide the position of the area frame 71, and thus, the image list with the second image arrangement area 63 decided by the area frame 71 as a display range is displayed on the display screen 31a of the display unit 31 (refer to FIG. 10). The third image arrangement area 64 includes the 16, in total, second image arrangement areas 63, four in the vertical direction and four in the horizontal direction, and therefore, when an image list with one second image arrangement area 63 as a display range is displayed, the image is displayed enlarged by a display magnification of 16.

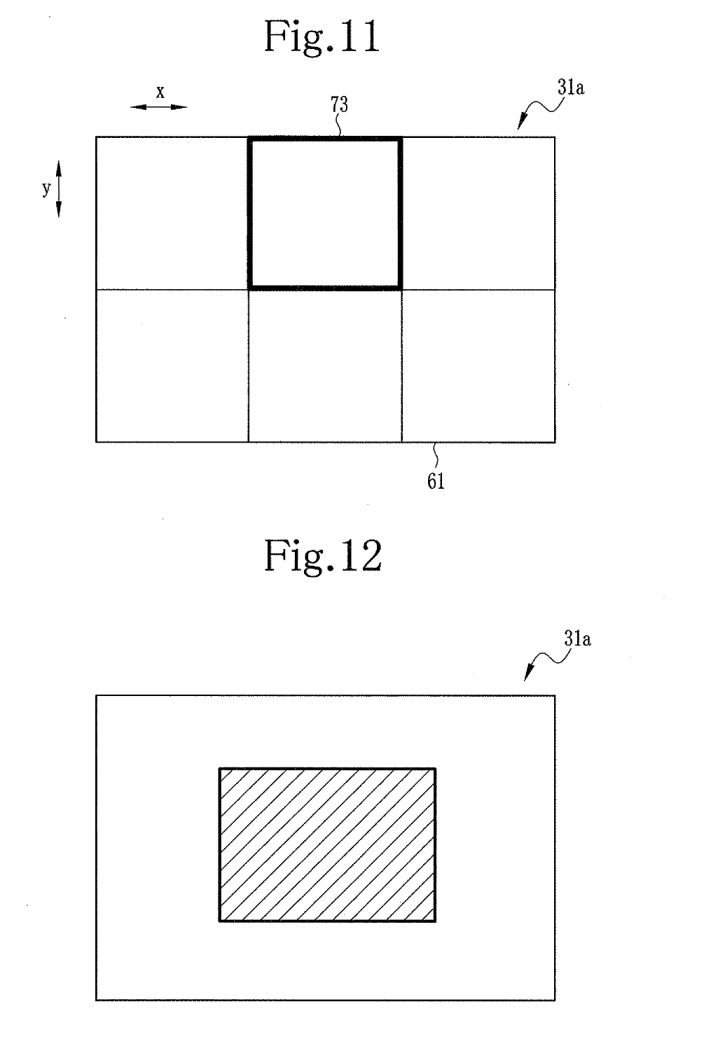

When the image list with the second image arrangement area 63 as a display range is displayed on the display screen 31a of the display unit 31, the area frame 72 indicating a selection area is displayed being overlapped with the image list. The area frame 72 has the size of the first image arrangement area 61. In this case also, a user operates the operation unit 26 to move the area frame 72 to a position intended by the user. At this time, the area frame 72, the area frame 71 moves while shifting one area each time so as to include the neighboring first image arrangement area 61. When the position of the area frame 72 reaches the position intended by the user, the user operates the operation unit 26 to decide the position of the area frame 72. After the decision, the user operates to enlarge the display, and thus, the image list with the first image arrangement area 61 decided by the area frame 72 as a display range is displayed on the display screen 31a of the display unit 31 (refer to FIG. 11). The second image arrangement area 63 includes the 16, in total, first image arrangement areas 61, four in the vertical direction and four in the horizontal direction, and therefore, when the image list with one first image arrangement area 61 as a display range is displayed, each image is displayed enlarged by a display magnification of 16.

When the image list with the first image arrangement area 61 as a display range is displayed on the display screen 31a of the display unit 31, an area frame 73 indicating a selection area is displayed being overlapped with the image list. The area frame 73 has the size of the search target image. In this case also, a user operates the operation unit 26 in the same manner to move the area frame 73 to a position intended by the user. At this time, the area frame 73 moves while shifting one area each time so as to include the neighboring search target image. When the position of the area frame 73 reaches the position intended by the user, the user operates the operation unit 26 to decide the position of the area frame 73. After that, the user operates the operation unit 26 to enlarge the display, and thus, the search target image on which the area frame 73 is overlapped moves so that the center of the search target image coincides with the center of the display screen 31a and then a still image from which the search target image is produced is displayed in the area shown by slashes in FIG. 12.

As described above, it is possible to decide and refine the range of search target images stepwise until the size of the area frame includes the minimum number of images. At this time, the positions of the search target images to be arranged are fixed, and therefore, the relationship of arrangement of the respective images does not change when the number of images is narrowed down. That is, if a user knows the relationship of arrangement of images to a certain level, it is possible for the user to refine images only by specifying an area that corresponds to the relationship of arrangement. Due to this, the number of times the user confirms images by his/her visual inspection can be reduced and the time and effort required to search for an image can be saved. If the images to be arranged are arranged in the order according to the shooting date, it is possible for a user to easily identify a range of the search target image if the user knows a position of any one of the images with the same shooting date. As a result of this, it is possible to shorten the time required to search for an image.

On the other hand, when a user wrongly decides the selection area in which images are displayed enlarged when refining images, the user operates to reduce the image using the operation unit 26. For example, when the image list with the second image arrangement area 63 as a display range is displayed on the display screen 31a of the display unit 31 and the display is reduced, the display of the image list with the second image arrangement area 63 as a display range is switched to the display of the image list with the third image arrangement area 64 as a display range 64 on the display screen 31a of the display unit 31. At this time, the third image arrangement area 64 displayed as an image list is the third image arrangement area 64 including the second image arrangement areas 63 previously displayed and at the same time, the same arrangement area as the third image arrangement area 64 displayed on the display screen 31a of the display unit 31 when the second image arrangement areas 63 to be displayed enlarged are selected. That is, it is made possible to return the immediately previous image list when there is no image intended in the selected range, and therefore, it is possible to easily change the range of search target images.

In the present embodiment, the image search server 15 produces list image data based on a display enlargement command transmitted from the electronic device 16 and transmits the list image data to the electronic device 16, however, this is not limited, and for example, it may also be possible for the image search server only to produce list image data using the thumbnail image data of all of the image files and transmit the produced list image data to the electronic device. In this case, it is only required for the electronic device 16 to cut out part of the received list image data by crop processing and cause the display to display the image list using the cut-out image data.

In the present embodiment, in the sequence by which the first image arrangement areas are formed, first, search target images are arranged in the four areas (the area 61a, the area 61b, the area 61c, and the area 61d) formed in the horizontal direction, and then, search target images are arranged in the four areas (the area 61e, the area 61f, the area 61g, and the area 61h) formed beneath the above-mentioned areas, however, the sequence is not limited to this, and for example, it is also possible to arrange search target images in units of four, in total, areas, two in the horizontal direction and two in the vertical direction. In this case, first, a search target image is arranged in the area 61a, and then, images are arranged in the area 61b, the area 61e, and the area 61f in this sequence. After that, search target images are arranged in all of the four, in total, areas, two in the horizontal direction and two in the vertical direction, and then, a search target image is arranged in the area on the right side of these areas (in this case, the area 61c). Then, after the four first image arrangement areas are formed in the horizontal direction, a search target image is arranged in the area 61i. In this manner, it is also possible to form the second image arrangement area 63 by combining the 16, in total, first image arrangement areas 61, four in the horizontal direction and four in the vertical direction.

In the present embodiment, the image search in the image file 49 as a target stored in the database 44 provided in the image search server 15 is described, however, this does not need to be limited. It is possible to insert the storage medium 32 into the media slot 29 in the display device 16a in the present embodiment and to connect the USB memory 33, the HDD 34, or the like to the I/F port 30. That is, it is possible to search an image file stored in the storage medium 32 inserted into the media slot 29 or an image file stored in the USB memory 33 or the HDD 34 inserted into the I/F port 30 as a target when searching for an image, in addition to the image file 49 stored in the database 44 provided in the image search server 15. In this case, the number of positions where image files to be searched when searching for an image is two or more, that is, the database 44 provided in the image search server 15, the storage medium 32 inserted into the media slot 29, the USB memory 33 and HDD 34 connected to the I/F port port 30, and the like, and therefore, the image searching system may be designed so that it is made possible to select a position in advance, where an image file used in an image search is stored.

In this case, in step S204 in the flowchart in FIG. 7, before an image is subjected to crop processing, the CPU 41 of the display device 16a is caused to select a position in advance where an image file used in an image search is stored. At the time of the selection, if the storage medium 32 inserted into the media slot 29, the USB memory 33 or the HDD 34 connected to the I/F port port 30 is selected as a position where an image file used in an image search is stored, an image file is read from a selected position and the read image file is transmitted from the display device 16a to the image search server 15. It is required for the image search server 15 only to perform crop processing of an image using the received image file.

When image files are stored across a plurality of positions as described above and an image list based on these image files is displayed, it is not clear where the image is stored. Because of this, it may also be possible to display a mark indicative of a position where an image file from which a search target image is produced on each search target image in an overlapping manner, such as “◯” on a search target image based on an image file stored in the database 44 and “x” on a search target image based on an image file stored in the storage medium 32 inserted into the media slot 29. Further, in addition to this, it is also possible to produce a bright display for a search target image based on an image file stored in the database 44 and a blurred display or a dark display for other search target images. Furthermore, in this case, it is also possible to switch image displays for each position of image files. In this case, it is preferable that the positions of search target images be not changed but remain fixed.

In the present embodiment, the case where a fixed number of image files is stored in the database 44 of the image search server 15 is explained, however, it is also possible to store a new image file in the database 44 of the image search server 15 and to delete image files that are no longer necessary.

For example, when a new image file is stored, the CPU 41 of the image search server 15 reads thumbnail image data from the newly stored image file and produces a search target image by performing crop processing and resolution conversion processing. Then, image data from which a search target image is produced and list image data are synthesized. The newly produced search target image is arranged based on the position of search target image arranged last in the template. As shown in FIG. 3, when search target images are arranged up to the arrangement area 62b of the first image arrangement area 61, the newly produced search target image is arranged in the arrangement area 62c of the first image arrangement area 61.

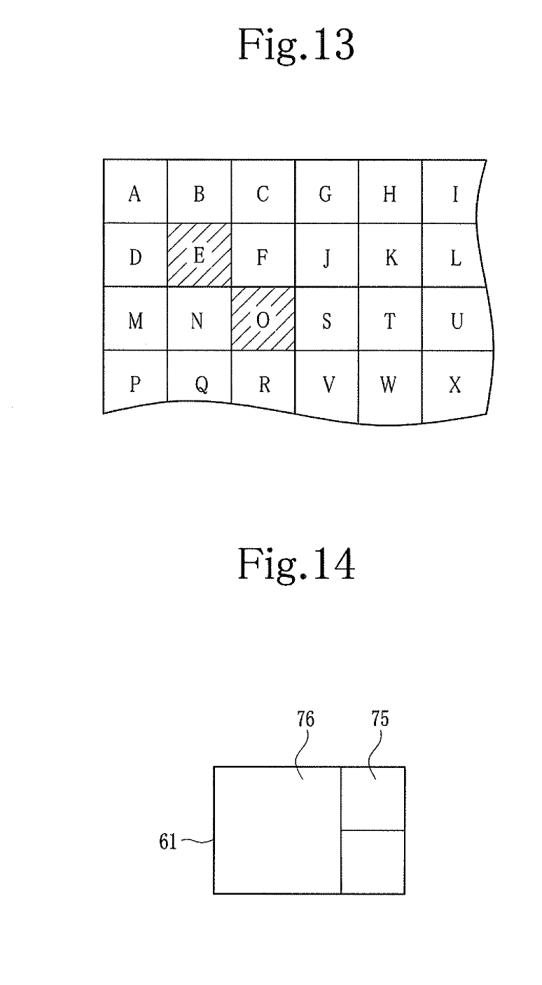

On the other hand, when an image file stored in the database 44 of the image search server 15 is deleted, the CPU 41 of the image search server 15 reads the list image data and deletes the search target image based on the deleted image file. At the same time of this, the CPU 41 reads the list image data and arranges no search target image in the arrangement area in which the deleted search target image used to be arranged. As shown in FIG. 13, when search target images are arranged in an arrangement area A to an arrangement area X, respectively, and if an image file from which search target images arranged in an arrangement area E and an arrangement area O are produced is deleted, the search target images arranged in the arrangement area E and the arrangement area O are deleted and these arrangement area E and arrangement area O are left empty. Due to this, the arrangement position of each search target image in the displayed image list remains unchanged, and therefore, it is made possible for a user to easily identify an area that is supposed to include a search target image if the user bears the arrangement of each search target image in the image list in mind.

It is also possible to arrange an image different from a search target image in the empty arrangement area from which a search target image has been deleted. As an image different from a search target image, for example, there are cited a netlike pattern image, an image painted in a predetermined color, and an image indicative of deletion. Further, in addition to this, such an image of flower or mountain may be arranged. When these images are arranged, a common image may be used or an image similar to images in the vicinity of the empty arrangement area from which a search target image has been deleted may be used. Furthermore, these images may be decided randomly.

In the present embodiment, when, for example, an image list with the third image arrangement area as a display range is displayed, the size of the area frame is adjusted to the size of the second image arrangement area and the amount of movement of the area frame at this time is assumed to be an amount corresponding to the width or height of the second image arrangement area. However, the amount of movement of the area frame does not need to be limited to this. As described above, the second image arrangement area includes a plurality of the first image arrangement areas arranged two-dimensionally, and therefore, the amount of movement of the area frame when the third image arrangement area is displayed may be set to an amount of movement corresponding to the width or height of the first image arrangement area rather than the amount of movement corresponding to the width or height of the second image arrangement area. According to this, it is made possible to increase the degree of freedom in moving the area frame, that is, the degree of freedom in selecting a search target area.

In the present embodiment, the first image arrangement area includes six, in total, search target images, two in the vertical direction and three in the horizontal direction, however, this is not limited and it may include six, in total, search target images, three in the vertical direction and two in the horizontal direction, or may include eight, in total, search target images, four in the vertical direction and two in the horizontal direction, etc. The number of search target images only needs to be set based on the aspect ratio of the display. Further, the number of the first image arrangement areas arranged in the second image arrangement area and the number of the second arrangement areas arranged in the third image arrangement area are set to 16 in total, four in the vertical direction and four in the horizontal direction, however, the number may be appropriately set to, for example, four in total, two in the vertical direction and two in the horizontal direction.

In addition to the above, the size of search target images to be arranged in the arrangement area is set fixed, however, there is a case where the size of some a search target image is different. As shown in FIG. 14, it is also possible to arrange search target images in the first image arrangement area 61 by a combination of, for example, an arrangement area 75 and an arrangement area 76 four times the size of the arrangement area 75.

In the present embodiment, the image searching system is the image searching system 10 in which the electronic device 16 and the image search server 15 are network-connected via the Internet 17, however, the image searching system is not limited to this but may be, for example, an electronic device capable of executing image search. In this case, examples of electronic device include a digital camera, a mobile-phone, a portable terminal, and a display device of a home-use game machine, a TV, or the like.

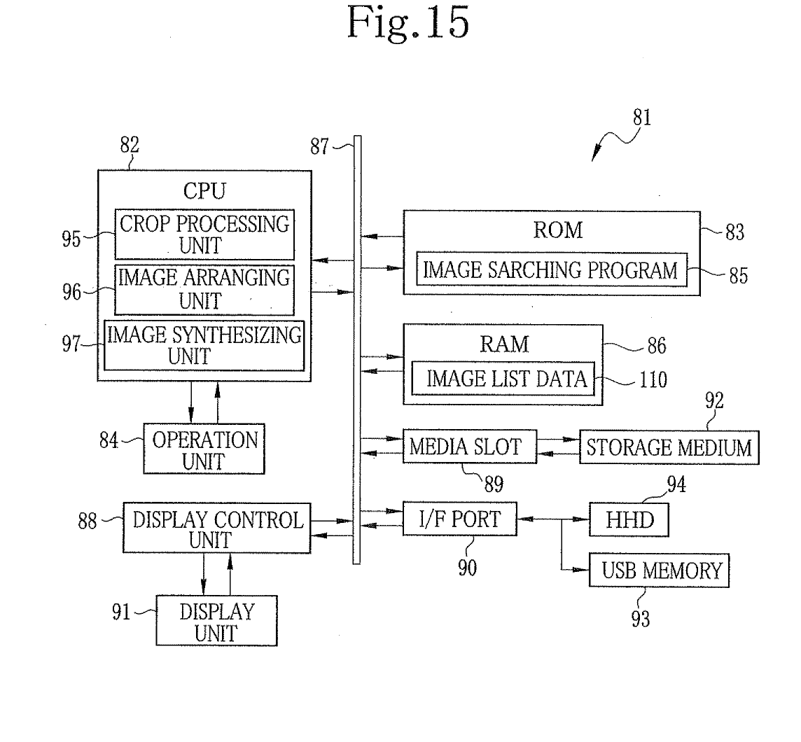

As shown in FIG. 15, an electronic device 81 is controlled totally by a CPU 82. The CPU 82 totally controls each part of the electronic device 81 by executing control programs (not shown schematically) stored in a ROM 83. To the CPU 82, an operation signal from an operation unit 84 is input, and therefore, processing based on the operation signal is performed. The ROM 83 stores an image searching program 85 in addition to the control programs. A RAM 86 temporarily stores numerical values and data produced at the time of control by the CPU 82. The CPU 82 is connected to a display control circuit 88, a media slot 89, an I/F port 90, etc., via a bus 87, in addition to the above-described ROM 83 and the RAM 86.

As the operation unit 84, a remote controller or the like is cited, in addition to the mouse or keyboard. The display control circuit 88 controls the drive of a display unit 91. Into and from the media slot 89, a storage medium 92, such as a memory card, an optical disc, and a magnetic disc, is inserted and removed. The I/F port 90 includes, for example, a connection port to which, for example, a cable terminal based on the USB standard is connected, a connection port to which a cable terminal based on the IEEE standard is connected, etc. Via the I/F port 90, a USB memory 93, a hard disc drive (HDD) 94, etc., are connected electrically.

The above-described CPU 82 comes to have functions of a crop processing unit 95, an image arranging unit 96, and an image synthesizing unit 97 by executing the image searching program 85 stored in the ROM 83. These functions are already explained in the present embodiment, and therefore, their details are omitted here.

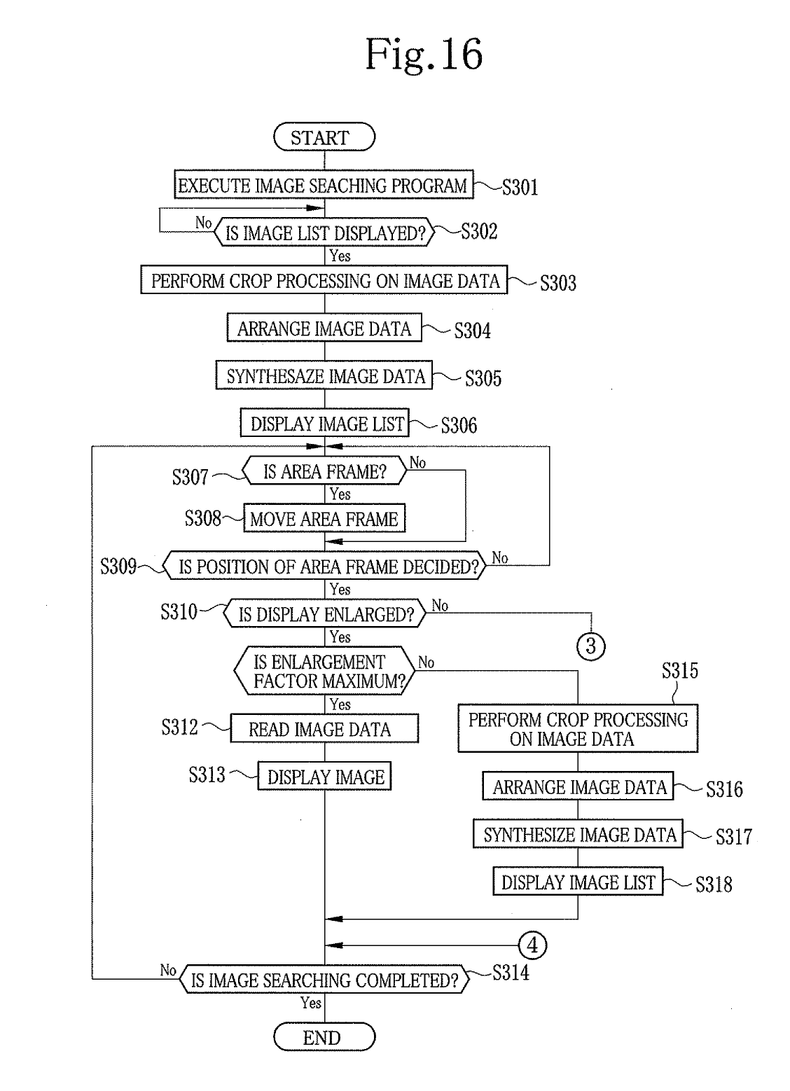

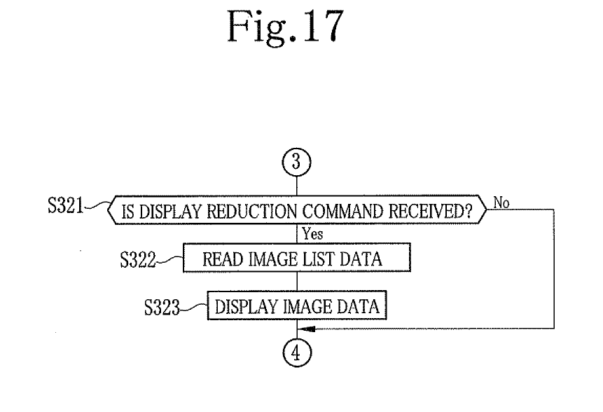

A procedure to search for an image in this electronic device will be described below based on the flowchart in FIG. 16 and FIG. 17. The execution of this flowchart is triggered by the turning on of the main power source.

Step S301 is processing to execute the image searching program. The CPU 82 reads the image searching program 85 stored in the ROM 83 and executes the read image searching program 85.

Step S302 is processing to determine whether or not to display an image list. To the CPU 82, an operation signal from the operation unit 84 is input. When the operation signal from the operation unit 84 is a signal to display an image list, the CPU 82 determines Yes in step S302. In this case, the flow advances to step S303. On the other hand, when the operation signal from the operation unit 84 is not the signal to display an image list, the CPU 82 determines No in step S302. In this case, the determination processing in this step S302 is executed repeatedly until the operation signal from the operation unit 84 is determined to be the signal to display an image list.

Step S303 is crop processing for image data. After confirming the presence/absence of the storage medium 92 inserted into the media slot 89 or the USB memory and the HDD 94 connected to the I/F port 90, the CPU 82 reads thumbnail image data of an image file stored therein. At this time, when the storage medium 92 is inserted into the media slot 89 and the USB memory 93 and the HDD 94 are connected to the I/F port 90, the CPU 82 may read an image file from any of these devices or may read image files from all of these devices. After reading image files as described above, the CPU 82 reads thumbnail image data of the image file. Then, the CPU 82 performs crop processing on the read thumbnail image data so that the aspect ratio of the image is 1:1.

Step S304 is processing to arrange image data. This processing to arrange images is already explained in step S205, and therefore, its details are omitted here.

Step S305 is processing to synthesize image data. The CPU 82 synthesizes a plurality of search target images to be arranged two-dimensionally by performing the processing in step S304. Consequently, the list image data 95 is produced. The list image data 95 is stored in the RAM 86.

Step S306 is processing to display an image list. The CPU 82 outputs the list image data 95 stored in the RAM 86 to the display control circuit 88. Upon receipt of the data, the display control circuit 88 displays images based on the list image data 95 on the display unit 91. Consequently, the image list is displayed on the display unit 91. When displaying the image list, the display control section 88 overlaps an area frame on the image list and stores them.

Step S307 is processing to determine whether or not to move the area frame. To the CPU 82, an operation signal based on the operation of the operation unit 84 is input. When determining that the operation signal is a signal to move the area frame, the CPU 82 determines Yes in step S307. In this case, the flow advances to step S308. On the other hand, when the operation signal input to the CPU 82 is not the signal to move the area frame, the CPU 82 determines No in step S307 and the flow advances to step S309.

Step S308 is processing to move the area frame. Performing step S308 means that the operation signal input to the CPU 82 is a signal indicative of an area frame, and therefore, the CPU 82 outputs a signal to move the area frame to the display control circuit 88. Upon receipt of the signal, the display control circuit 88 moves the area frame overlapped on the display unit 91 in a direction based on the operation signal.

Step S309 is processing to determine whether or not to decide the position of the area frame. When the operation signal from the operation unit 84 is a signal to decide the position of the area frame, the CPU 82 determines Yes in step S309. In this case, the flow advances to S310. On the other hand, when there is no operation signal from the operation unit 84 or the signal is a different one, the CPU 82 determines No in step S309. In this case, the flow returns to step 307.

Step S310 is processing to determine whether or not to enlarge a display. When the operation signal based on the operation of the operation unit 84 is a signal to enlarge a display, the CPU 82 determines Yes in step S310 and the flow advances to step S311. On the other hand, when the signal is not the signal to enlarge a display, the CPU 82 determines No in this step S310 and the flow advances to step S321.

Step S311 is processing to determine whether or not the specified enlargement factor is the maximum. The CPU 82 has acquired information about the size of the area frame from the display control circuit 88. The CPU 82 determines whether or not the size of the area frame is that of the search target image based on the information. For example, when the size of the area frame is that of search target image, the specified enlargement factor is the maximum, and therefore, the CPU 82 determines Yes in step S311. In this case, the flow advances to step S312. On the other hand, when the size of the area frame is larger than or equal to that of the first image arrangement area 61, the specified enlargement factor is not the maximum, and therefore, the CPU 82 determines No in step S311. In this case, the flow advances to step S315.

Step S312 is processing to read image data. In step S312, it has been determined that the size of the area frame is that of the search target image. Further, to the display enlargement command, the information about the position of the area frame is attached. The CPU 82 identifies a search target image from the information about the position of the area frame and the list image data 95 stored in the RAM 86. Then, the CPU 82 reads thumbnail image data or still image data from the image file from which the identified searching image is produced.

Step S313 is processing to display an image. Having already read thumbnail image data or still image data from the image file from which the identified search target image is produced, and therefore, the CPU 82 outputs the image data to the image control circuit 88. Upon receipt of the data, the display control circuit 88 displays images based on the image data on the display unit 91.

Step S314 is processing to determine whether or not to end the image search. When the operation signal output from the operation unit 84 to the CPU 82 is a signal to end the image search, the CPU 82 determines Yes in this step S314 and ends the processing relating to the image search. On the other hand, when the operation signal output from the operation unit 84 to the CPU 82 is a signal other than the signal to end the image search, the CPU 82 determines No in step S314. In this case, the flow returns to step S307.

When the specified enlargement factor is not the maximum according to the result of the determination processing in step S311, the result of the determination processing in step S311 is No. In this case, the flow advances to step S315.

Step S315 is crop processing for image data. The CPU 82 identifies a search target image included in the area frame from the information about the position of the area frame and the list image data 95. Then, the CPU 82 reads thumbnail image data from the image file based on the identified search target image. Then, the CPU 82 cuts out the center part of the image so that the aspect ratio of the image based on the thumbnail image data is 1:1.

Step 316 is processing to arrange image data. The CPU 82 performs resize processing on the image data having been subjected to the crop processing to make the image size fixed and thus produces image data for searching. The CPU 82 arranges each piece of image data using the produced image data for searching. The procedure to arrange each piece of image data is the same as that in step S216 in FIG. 7, and therefore, its explanation is omitted.

Step S317 is processing to synthesize image data. In step S316, all of the image data for searching has been arranged, and therefore, the CPU 82 synthesizes the arranged image data for searching to produce the list image data 95. The produced list image data 95 is stored in the RAM 86.

Step S318 is processing to display an image list. The CPU 82 outputs the list image data 95 produced in step S317 to the display control circuit 88. Upon receipt of the data, the display control circuit 88 causes the display unit 91 to display the image list. After this processing is performed, the flow advances to step S314.

When the result of the determination processing in step S310 is No, that is, when the received command is not the display enlargement command, the flow advances to step S321.

Step S321 is processing to determine whether or not to reduce a display. When the operation signal based on the operation of the operation unit 84 is a signal to reduce a display, the CPU 82 determines Yes in step S321 and the flow advances to step S322. On the other hand, when the operation signal is not the signal to reduce a display, the CPU 82 determines No in this step S321 and the flow advances to step S314.

Step S322 is processing to read list image data. The CPU 82 reads the second new list image data 95 from the past list image data 95 stored in the RAM 86.

Step S323 is processing to display an image list. The CPU 82 outputs the list image data 95 produced in step S317 to the display control circuit 88. Upon receipt of the data, the display control circuit 88 causes the display unit 91 to display an image list. After this processing is performed, the flow advances to step S314. As described above, when the display reduction command is received, it is only required to read the list image data 95 stored in the RAM 86 without the need to newly produce the list image data 95, and therefore, it is possible to save time and effort required to produce the list image data 95.

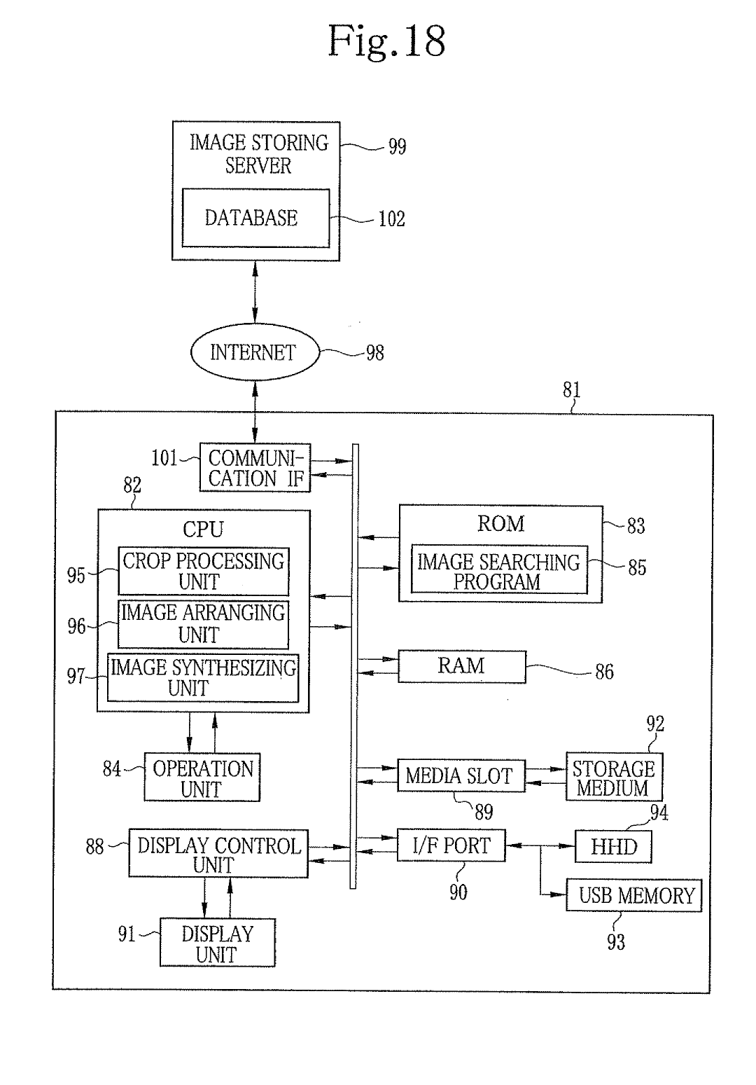

As shown in FIG. 18, it is also possible to network-connect the above-described electronic device 81 with an image storing sever 99 via an Internet 98. In this case, the ROM 83 is caused to store a WEB browser 100. When the CPU 82 executes the WEB browser 100, the electronic device 81 is network-connected with the image storing server 99 via the Internet 98. Symbol 101 denotes a communication I/F. In this case, it is made possible to read thumbnail image data from an image file stored in a database 102 provided in the image storing server 99 and to cause the display to display the image list.

As the present invention, the image searching system that searches for an image and the electronic device capable of searching for an image are explained, however, besides the above, the present invention may be an image searching program capable of causing a computer to execute the functions of the crop processing unit 51, the image arranging unit 52, and the image synthesizing unit 53 in FIG. 1, or the functions of the crop processing unit 95, the image arranging unit 96, and the image synthesizing unit 97 in FIG. 15, or the functions of the flowchart in FIG. 16 and FIG. 17. It is preferable for the image searching program to be stored in a computer-readable storage medium, such as a memory card, an optical disc, and a magnetic disc.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An image searching system comprising:
a display unit capable of displaying a plurality of images arranged two-dimensionally;
a range determining unit performing a determination of a search target range from an arrangement area of the plurality of images displayed on the display unit using a selected range set in advance;
an image refining unit refining search target images by performing the determination of the search target range by the range determining unit a plurality of times until the selected range becomes a minimum selected range while gradually reducing the selected range;
an image selecting unit selecting any of images included in the selected range when the selected range becomes the minimum selected range by performing the refining of the search target images by the image refining unit; and
a display control unit causing the display unit to display, while maintaining a state of arrangement, images included in the search target range being determined each time the search target range is determined by the range determining unit when refining the search target images by the image refining unit, and causing the display unit to display a selected image when any of the images included in the selected range is selected by the image selecting unit.

2. The image searching system according to claim 1, wherein
the display control unit redisplays the plurality of images displayed on the display unit at the time of determining the search target range when the search target range determined by the range determining unit is changed in a process of refining the search target images by the image refining unit.

3. The image searching system according to claim 1, wherein
the minimum selected range is a range in a rectangle shape when a preset number of images is arranged in a matrix, and the selected range is a range similar to the minimum selected range and different from the minimum selected range in size.

4. The image searching system according to claim 1, further comprising
an image arranging unit arranging the plurality of images two-dimensionally by arranging a group of images in a predetermined arrangement sequence, the group of images has images arranged in accordance with the minimum selected range.

5. The image searching system according to claim 4, wherein
the plurality of images is arranged in fixed positions; and
the image arranging unit, when any of the plurality of images is deleted, keeps an area where a deleted image is once arranged empty and arranges the images excluding the deleted image.

6. The image searching system according to claim 4, wherein
the plurality of images is arranged in fixed positions; and
the image arranging unit, when any of the plurality of images is deleted, first arranges an image different from the plurality of images in an area where a deleted image is once arranged and then arranges the images excluding the deleted image.

7. The image searching system according to claim 1, having:
an electronic device including at least the display unit and the display control unit;
a server capable of connecting to the electronic device via a network; and
an image storing unit storing the plurality of images, wherein
the image storing unit is provided in at least one of the electronic device and the server.

8. An image searching system comprising:
a display unit capable of displaying a plurality of images arranged two-dimensionally;
a range determining unit performing a determination of a search target range from an arrangement area of the plurality of images displayed on the display unit using a selected range set in advance;
an image refining unit refining search target images by performing the determination of the search target range by the range determining unit a plurality of times until the selected range becomes a minimum selected range while gradually reducing the selected range; and
a display control unit causing the display unit to display, while maintaining a state of arrangement, images included in the search target range being determined each time the search target range is determined by the range determining unit when refining the search target images by the image refining unit.

9. An image searching apparatus comprising:
a display unit capable of displaying a plurality of images arranged two-dimensionally;
a range determining unit performing a determination of a search target range from an arrangement area of the plurality of images displayed on the display unit using a selected range set in advance;
an image refining unit refining search target images by performing the determination of the search target range by the range determining unit a plurality of times until the selected range becomes a minimum selected range while gradually reducing the selected range;
an image selecting unit selecting any of images included in the selected range when the selected range becomes the minimum selected range by performing the refining of the search target images by the image refining unit; and
a display control unit causing the display unit to display, while maintaining a state of arrangement, images included in the search target range being determined each time the search target range is determined by the range determining unit when refining the search target images by the image refining unit, and causing the display unit to display a selected image when any of the images included in the selected range is selected by the image selecting unit.

10. A computer-readable storage medium storing an image searching program to cause a computer to execute:
a range determining step performing a determination of a search target range from an arrangement area of a plurality of images to be displayed using a selected range set in advance;
an image refining step refining search target images by performing the determination of the search target range in the range determining step a plurality of times until the selected range becomes a minimum selected range while gradually reducing the selected range;
a first display step causing the display unit to display, while maintaining a state of arrangement, images included in the search target range being determined each time the search target range is determined in the range determining step when refining the search target images in the image refining step;
an image selecting step selecting any of images included in the selected range when the selected range becomes the minimum selected range by performing the refining of the search target images in the image refining step; and
a second display step displaying a selected image in the image selecting step.
